(19) United States
(12) Patent Application Publication
(10) Pub. No.: US 2008/0029972 A1
(43) Pub. Date: Feb. 7, 2008

(54) Low Leak O-Ring Seal

(75) Inventors: David B. Smathers, Columbus, OH (US); Robert S. Bailey, Grove City, OH (US)

Correspondence Address: WEGMAN, HESSLER & VANDERBURG, 6055 ROCKSIDE WOODS BOULEVARD, SUITE 200, CLEVELAND, OH, 44131, US

(73) Assignee: TOSOH SMD, INC., GROVE CITY, OH (US)

(21) Appl. No.: 11/658,112

(22) PCT Filed: Oct. 7, 2005
(86) PCT No.: PCT/US05/36254

§ 371 Date: Jan. 22, 2007

Related U.S. Application Data
(60) Provisional application No. 60/617,022, filed on Oct. 8, 2004.

(51) Int. Cl. F16J 15/06

(52) U.S. Cl. 277/641

(57) ABSTRACT

A vacuum seal (1) having an O-ring (12) between two mating parts (2) (6). One of the mating parts has a groove (10) configured to receive the O-ring (12). The groove (10) has a modified dovetail shape with at least one side wall (14) having a compound slope formed with a first portion (22) forming an angle of less than 90 degrees with respect to a base wall (18) and a second portion (24) extending substantially perpendicular to the sealing face (4) of the mating part. The cross-sectional area of the groove is less than 95% of the cross sectional area of the O-ring and the width (W) of the groove mouth (20) is at least 94% of the diameter (D) of the O-ring.

### CROSS REFERENCE TO RELATED APPLICATION

The present application claims priority under 35 U.S.C. §119(e) to U.S. Provisional Patent Application No. 60/617,022, filed Oct. 8, 2004.

### BACKGROUND OF THE INVENTION

### Description of Related Art

In many semiconductor hardware configurations, maintaining a seal between components is an important design consideration. Elastomeric O-rings made of natural or synthetic rubber are commonly used to make a vacuum or water seal between metal surfaces of two adjoining parts. The type of rubber used in a seal is chosen based on the type of fluid to be sealed and the temperature of the environment in which the seal is to be employed. Seals for corrosive fluids and strong solvents or for high temperature applications often require the rubber to be a fluoroelastomer or perfluoroelastomer.

Typically, the sealing face of a first part has formed therein an annular groove or seat. The O-ring is confined in the groove and seals to a flat surface on the meeting part. The annular O-ring usually has an axial dimension greater than the depth of the groove so as to project from the sealing face. Accordingly, the O-ring will be compressed in the groove upon being engaged by the confronting sealing surface of the mating part. While no O-ring is perfect and some amount of gas will cross the seal due to the pressure gradient, a tighter seal will reduce the leak rate across the seal.

Simple grooves typically have a generally square cross-sectional shape in order to capture the O-ring and hold it in place during the assembly of the two meeting surfaces. The O-ring is retained in the sealing face grooves by an interference fit usually at the outer diameter of the O-ring. One disadvantage of square-shaped groove is the O-ring often falls out of the groove during handling. Additionally, in semi-dynamic applications, wherein one of the surfaces in contact with the O-ring moves, the O-ring can shift and twist in its seat or the O-ring may be physically damaged or broken and fluid can then move around the seal and cause a leak.

In the past, this problem has been partially solved by designing the seat to have a dovetail shaped cross-section, which more firmly holds the O-ring in place. FIG. 2 illustrates an O-ring in a prior art groove having a single dovetail shape and FIG. 3 illustrates an O-ring in a prior art groove having a double dovetail shape. In the dovetail design, at least one of the side wall slants toward the mouth of the groove such that wall is at an angle of less than 90 degrees with respect to the base wall of the groove. As such, the groove will be narrower where the groove is coplanar with the mating surface. Therefore, dovetail grooves have the advantages of being able to secure the O-ring in the groove, while allowing an upper portion of the O-ring to protrude out of the groove and contact the surface of the mating part and allowing the O-ring to spread out within the groove under compression.

However, it can be very difficult to install an O-ring into a dovetail shaped groove without damaging or twisting the seal because the opening of the groove is smaller compared to the cross-sectional area of the groove when compared to square-shaped grooves. For example, for the design of normal a O-ring single dovetail groove, the Parker O-ring Handbook 5700 specifies a volume fill ratio (i.e., the cross section of the O-ring divided by the cross section of the groove) of approximately 86-90%. For semiconductor applications, the handbook recommends increasing the fill ratio to 95%. In both cases, the basic design includes a mouth having a width equal to 94% of the O-ring cross section diameter to allow the insertion of the O-ring into the groove. If the mouth is smaller than this, the installation is very difficult.

However, in some applications, it would be desirable to have a fill ratio of greater than 100%, and even greater than 105% (i.e., the cross section of the O-ring being 105% of the cross section of the groove) and still maintain a mouth that is at least 94% of the O-ring diameter. If the sidewalls of the groove are formed with steeper angle so as to permit the size of the mouth to be enlarged relative the cross section of the groove and ease installation, the O-ring is not held securely in the groove.

It would be an advantage to have a dovetail shaped seat configured to more readily received the rubber seal during installation and which, when installed, provides excellent semi-dynamic sealing properties. It would be desirable to make the O-ring fit tightly within the groove while maintaining an ease of installation for single or double dovetail designs.

### SUMMARY OF THE INVENTION

One aspect of the invention is directed to an improved vacuum seal that includes an O-ring having a circular cross-section with a diameter D. The vacuum seal also includes a first mating part having a first sealing surface with a groove formed therein configured to receive the O-ring. The groove has a radially outer side wall, a radially inner side wall and a bottom wall that extends between the outer and inner side walls with a groove mouth having a width W in the first sealing surface between said outer and inner side walls. The vacuum seal also includes a second mating part having a second sealing surface, wherein the second sealing mates with the first sealing surface. The groove has a modified dovetail shape with at least one side wall having a compound slope formed with a first portion forming an angle of less than 90 degrees with respect to the base wall and a second portion extending substantially perpendicular to the sealing face. In one aspect of the invention, the cross-sectional area of the groove is less than 97% of the cross sectional area of the O-ring and the width W of the groove mouth is at least 94% of the diameter D of the O-ring.

Another aspect of the invention is directed to an improved vacuum seal having an O-ring having a circular cross-section with a diameter D. The vacuum seal also includes a first mating part having a first sealing surface with a groove formed therein configured to receive the O-ring, wherein the groove has a radially outer side wall and a radially inner side wall with a groove mouth having a width W in the first sealing surface between the outer and inner side walls. The vacuum seal also includes a second mating part having a second sealing surface, wherein the second sealing mates with the first sealing surface. The groove has a modified dovetail shape with at least one side wall having a compound slope formed with a first portion slanting toward the mouth of the groove and a second portion extending substantially perpendicular to the sealing face.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of two mating surfaces with an annular groove receiving an O-ring to form a seal;

FIG. 2 is a sectional view of one mating surface showing a prior art single dovetail groove;

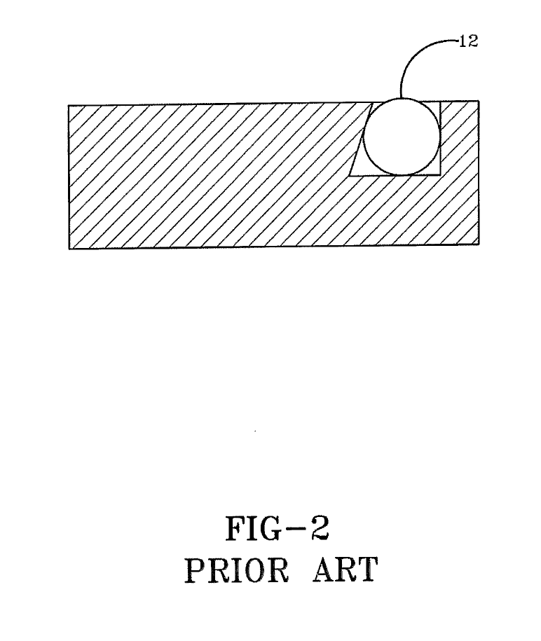

FIG. 3 is a sectional view of one mating surface showing a prior art double dovetail groove;

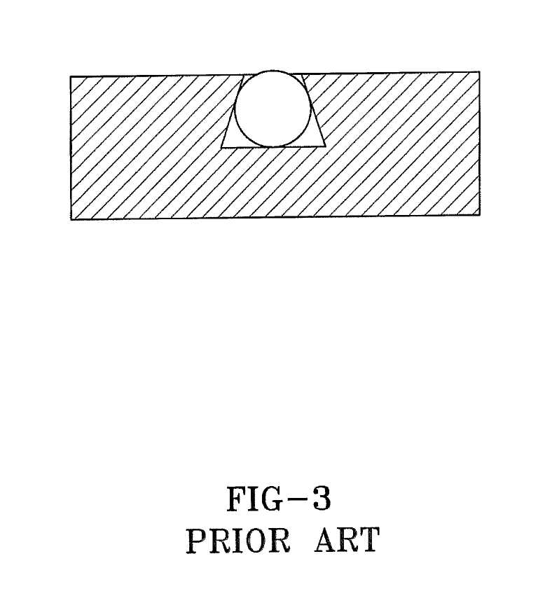

FIG. 4 is a sectional view of one mating surface showing a modified single dovetail groove according to an embodiment of the invention;

FIG. 5 is a sectional view of one mating surface showing a modified double dovetail groove according to another embodiment of the invention;

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

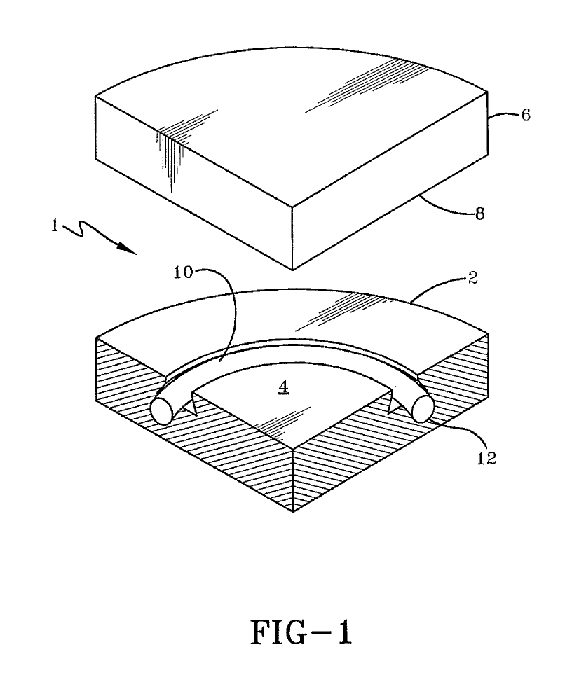

Referring to FIG. 1, a vacuum seal 1 has a first mating part 2 with a sealing face 4 that mates with a second mating part 6 having a corresponding mating face 8. In one embodiment, the mating parts 2, 6 are used in sealing the target to the chamber in order to achieve high vacuum in a physical vapor deposition sputtering chamber. A groove 10 is formed within the sealing face 4 of the first mating part 2. As illustrated, the groove 10 is an annular groove, however, one skilled in the art will understand that the groove may have any shape required by the specific vacuum seal 1. An O-ring or seal 12 is received in the groove 10 and provides a seal when the mating parts 2 and 6 are brought together. The O-ring 12 desirably has a typical circular cross-section and can be made using materials customary in the art and therefore need not be discussed in further detail.

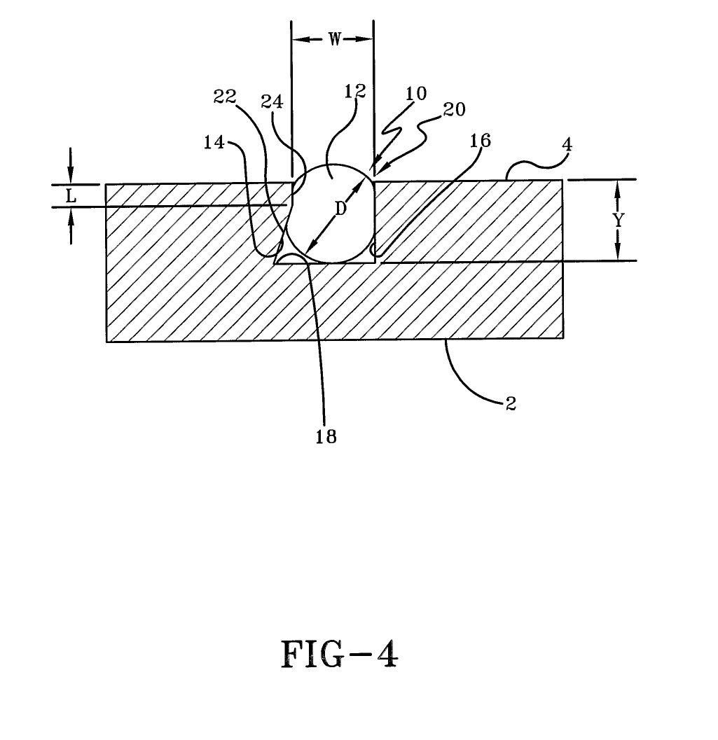

Turning now to FIG. 4, according to the invention the groove 10 in the sealing face 4 has a modified dovetail shape. The groove 10 has a radially inner side wall 14, a radially outer side wall 16, and a bottom wall 18 that extends between the side walls 14, 16. In one embodiment, the bottom wall 18 is generally parallel to the sealing face 4 and is spaced from the sealing face 4 at a desired depth Y. However, one skilled in the art will understand that the bottom wall 18 need not be parallel to the sealing face 4. Desirably, the depth Y of the bottom wall 18 is between about 0.07 inches and about 0.2 inches, and more preferably between about 0.10 and 0.12 inches for the case where the O-ring has a diameter of 0.139″ (standard ⅛ size). One skilled in the art will recognize that the overall size of the O-ring 12 needed for any particular application will be related to the size of the modified dovetail-shaped groove 10 in which the O-ring 12 is to be positioned. Desirably, the diameter D of the O-ring 12 used in the vacuum seal 1 is about is about 105% to about 150% of the depth Y of the bottom surface 18. The groove 10 has a mouth or opening 20 in the sealing face 4 between where the inner side wall 14 and outer side wall 16 meet the sealing face 4 having a width W so that the O-ring 12 can be readily inserted into the groove 10.

In the embodiment illustrated in FIG. 4, the groove 10 has a modified single dovetail shape with a first or lower portion 22 of the inner side wall 14 slanting towards the mouth 20 of the groove 10 such that the first portion 22 inclines at an angle less than 90 degrees with respect to the base wall 18. Desirably, the first portion 22 has a slope relative the base wall 18 of between 60 and 80 degrees, and more preferably between about 66 and 75 degrees. According to the invention, the inner side wall 14 has a compound slope such that a second or upper portion 24 of the inner side wall 14 extends at a different angle than the first portion 22. Of course, the terms lower and upper are used herein to aid in describing the illustrated embodiment and are not intended to be limiting. The second portion 24 is located closer to the sealing face 4 than the first portion 22 and is desirably substantially perpendicular to the sealing face 4. By substantially perpendicular, it is meant that the second portion 24 is within about 5 degrees from being perpendicular to the sealing face 4. In the case of a standard ⅛ O-ring (0.139″ diameter) the second portion 24 desirably has a length L of between about 0.01 inches and 0.10 inches, and more desirably between about 0.01 inches and 0.05 inches. Stated another way, the second portion 24 desirably has a length L that is between about 8% and about 50% of the depth Y of the groove 10, and more desirably, between about 10% and about 20% of the depth Y of the groove 10.

The radially outer side wall 16 is perpendicular to the sealing face 4 and base wall 18 giving the shape of the groove 10 a modified single dovetail shape. In the modified single dovetail-shaped groove 10, the sidewall having the compound slope is desirably the radially inner sidewall 14 of the groove 10. However, one skilled in the art will understand that the compound slope can be on the radially outer sidewall 16 without departing from the scope of the invention. Desirably, the groove 10 is formed such that the junctions or corners between the side walls 14, 16 and bottom wall 18 have a radius greater than about 0.005 inches and more desirably the upper corners have a radius between about 0.005 inches and about 0.020 inches and the lower corners have a radius between about 0.01 inches and about 0.05 inches.

The compound slope on the side wall 14 enables the cross-sectional area of the groove 10 to be less than about 97% of the cross sectional area of the circular O-ring 12 (i.e., fill ratio greater than 103%), and more preferably less than about 95% (i.e., fill ratio greater than 105%), and yet permit the groove 10 to have a mouth 20 that has a width W that is at least 90%, desirably at least 94% and more desirably at least 95% of the cross sectional diameter D of the O-ring 12 to readily enable the installation of the O-ring 12. As used herein, cross-sectional area is defined as the area of the section through a specified point that is perpendicular to the axis of the groove 10 and thus will be the section through a point having the minimum area.

It should be understood that radii exist on all corners or intersections of straight sections and that these radii shall be chosen to achieve the desired dimensions. The sharp corner dimension defines the volume while the radii cause the opening to be larger. The actual opening is often called the “gland” and is desirably 90% to 99% of the O-ring diameter and preferably 94 to 96% of the O-ring diameter. The sharp corner dimension is chosen to achieve the total groove volume to be less than 95% of the O-ring volume.

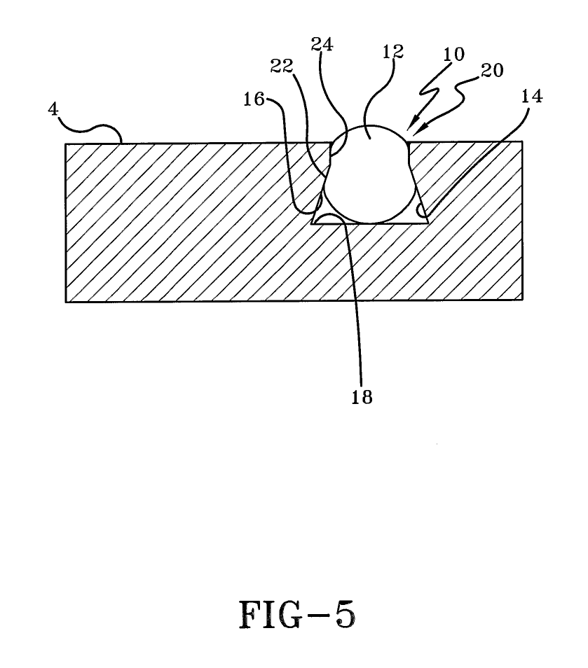

Turning now to FIG. 5, a second embodiment of a groove 10 according to the invention is illustrated. In this embodiment, the groove 10 has a modified double dovetail shape. The modified dovetail shape of groove 10 is obtained by having first or lower portions 22 of both side walls 14, 16 extend toward each other as each side wall 14, 14 extends from the bottom wall 18. Thus, the first portions of both side walls 14, 16 are at an angle of less than 90 degrees with respect to the base wall 18. Each of the side walls 14, 16 also have a compound shape such that the second portion 24 of the side wall extends at a different angle than the first portion 22. Desirably, the second portions 24 of the side walls 14, 16 are perpendicular to the sealing face 4.

In yet an additional embodiment, the groove 10 can have a modified double dovetail shape with one side having a compound shape and one side having a traditional dovetail shape.

The present disclosure will now be described more specifically with reference to the following examples. It is to be noted that the following examples are presented herein for purpose of illustration and description; they are not intended to be exhaustive or to limit the disclosure to the precise form disclosed.

### EXAMPLE 1

A modified single dovetail groove having a mouth 20 having a sharp corner opening having a width of 0.125 inches (gland opening of 0.132″) and a depth of 0.105 inches. The first portion 22 of the sidewall has a slope of 75 degrees. The groove 10 has a fill ratio of 104% and the compound slope of the sidewall 14 provides acceptable installation of the O-ring.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. An improved vacuum seal comprising:
an O-ring having a circular cross-section with a diameter D;
a first mating part having a first sealing surface with a groove formed therein configured to receive the O-ring, wherein said groove has a radially outer side wall, a radially inner side wall and a bottom wall that extends between said outer and inner side walls with a groove mouth having a width W in the first sealing surface between said outer and inner side walls; and
a second mating part having a second sealing surface, wherein said second sealing mates with said first sealing surface;
wherein said groove has a modified dovetail shape with at least one side wall having a compound slope formed with a first portion forming an angle of less than 90 degrees with respect to the base wall and a second portion extending substantially perpendicular to the sealing face.

2. A vacuum seal according to claim 1 wherein the cross-sectional area of the groove is less than 97% of the cross sectional area of the O-ring and the width W of the groove mouth is at least 94% of the diameter D of the O-ring.

3. A vacuum seal according to claim 1 wherein the bottom surface is parallel to the mating surface.

4. A vacuum seal according to claim 1 wherein the groove has a modified single dovetail shape such that one sidewall is square and one sidewall has a compound slope.

5. A vacuum seal according to claim 1 wherein the groove has a modified double dovetail shape.

6. A vacuum seal according to claim 5 wherein both sidewalls have a compound slope.

7. A vacuum seal according to claim 1 wherein the second portion of the sidewall with the compound slope has a length L of between about 0.01″ and about 0.05″.

8. A vacuum seal according to claim 1 wherein the first portion of the sidewall with the compound slope forms an angle with the bottom wall that is between about 60 and about 80 degrees.

9. A vacuum seal according to claim 1 wherein the cross-sectional area of the groove is less than 94% of the cross sectional area of the O-ring and the width W of the groove mouth is at least 95% of the diameter D of the O-ring.

10. An improved vacuum seal comprising:
an O-ring having a circular cross-section with a diameter D;
a first mating part having a first sealing surface with a groove formed therein configured to receive the O-ring, wherein said groove has a radially outer side wall and a radially inner side wall with a groove mouth having a width W in the first sealing surface between said outer and inner side walls; and
a second mating part having a second sealing surface, wherein said second sealing mates with said first sealing surface;
wherein said groove has a modified dovetail shape with at least one side wall having a compound slope formed with a first portion slanting toward the mouth of the groove and a second portion extending substantially perpendicular to the sealing face.

11. A vacuum seal according to claim 10 wherein the cross-sectional area of the groove is less than 97% of the cross sectional area of the O-ring and the width W of the groove mouth is at least 94% of the diameter D of the O-ring.

12. A vacuum seal according to claim 11 wherein the groove further includes a bottom surface that is substantially parallel to the mating surface, with the first portion of the side wall forms an angle with the bottom wall that is between about 60 and about 80 degrees.

13. A vacuum seal according to claim 12 wherein the second portion has a length L that is between about 10% and about 20% of a depth Y of the groove.

14. A vacuum seal according to claim 10 wherein the groove has a modified single dovetail shape such that one sidewall is square and one sidewall has a compound slope.

15. A vacuum seal according to claim 10 wherein the groove has a modified double dovetail shape.

16. A vacuum seal according to claim 14 wherein both sidewalls have a compound slope.
